(19) United States
(12) Patent Application Publication
(10) Pub. No.: US 2026/0019773 A1
(43) Pub. Date: Jan. 15, 2026

(54) 911 VOWIFI LOCATION ADDRESS UPDATE AND VALIDATION

(71) Applicant: DISH Wireless L.L.C., Littleton, CO (US)

(72) Inventor: Raghavendhra Rao, Carnation, WA (US)

(21) Appl. No.: 18/767,339

(22) Filed: Jul. 9, 2024

(51) Int. Cl. H04W 4/029

(52) U.S. Cl. CPC H04W 4/029

(57) ABSTRACT

A method of automatically updating active registered locations for use in emergency calls may include determining, by a computing device, a current location of the computing device based at least in part on sensors of the computing device. The method may include accessing, by the computing device, data indicating each of a plurality of registered locations and an active registered location associated with the computing device. The method may include determining, by the computing device, that the current location corresponds to a second registered location, different than the active registered location. The method may include updating, by the computing device, the active registered location to indicate the current location.

### CROSS-REFERENCES TO RELATED APPLICATIONS

This application is related to Attorney Docket No. P2024-02-01 (1428944), filed concurrently, entitled “INITIAL REGISTERED LOCATION INPUT WITH CHECKS,” the disclosure of which is hereby incorporated in its entirety for all purposes.

### BACKGROUND

A person in an emergency situation may request help using a user device such as a mobile phone to dial a designated emergency number, such as 911 in the United States or 112 in many European countries, or a direct access phone number for a local emergency service provider (e.g., an emergency dispatch center). This emergency call is assigned by the dispatch center to one or more first responders by the emergency service provider. In order to dispatch emergency personnel to aid the person in the emergency situation, the emergency service provider needs the location of the emergency. However, the person calling for emergency help may not be able to provide their location, location information provided by the caller or the user device may not be complete, the location information may not be sufficiently accurate, or some combination thereof. As a result, emergency service providers can find it challenging to identify and ascertain the real-world location of where the caller and/or emergency are located. Therefore, it is desired for improving the accuracy of determining the location of the device used by the caller requesting emergency help.

### BRIEF SUMMARY

A method of automatically updating active registered locations for use in emergency calls may include determining, by a computing device, a current location of the computing device based at least in part on sensors of the computing device. The method may include accessing, by the computing device, data indicating each of a plurality of registered locations and an active registered location associated with the computing device. The method may include determining, by the computing device, that the current location corresponds to a second registered location, different than the active registered location. The method may include updating, by the computing device, the active registered location to indicate the current location.

In some embodiments, the computing device may update the active registered location automatically. The method may include responsive to determining that the current location corresponds to the second registered location, different than the active registered location. The method may include generating, by the computing device, a notification indicating that the current location corresponds to the second registered location, different than the active registered location. The method may include receiving, by the computing device, an input causing the computing device to update the active registered location to indicate the current location.

In some embodiments, the method may include determining, by the computing device, a particular registered location of the plurality of registered locations that is an unvisited registered location. The method may include generating, by the computing device, a notification indicating that the particular registered location has not been visited. The method may include receiving, but the computing device, an input causing the computing device to remove the particular registered locations from the plurality of registered locations. The active registered location may be updated based at least in part on the computing device connecting to a particular wireless network. The method may include determining, by the computing device, that the computing device has moved to a certain proximity away from the active registered location. The method may include updating the active registered location to indicate the current location. The current location may be determined at least in part by network information associated with a WiFi network.

A system may include one or more processors and a computer-readable medium including instructions that, when executed by the one or more processors, cause the system to perform operations. According to the operations, the system may determine, by a computing device, a current location of the computing device based at least in part on sensors of the computing device. The system may access, by the computing device, data indicating each of a plurality of registered locations and an active registered location associated with the computing device. The system may determine, by the computing device, that the current location corresponds to a second registered location, different than the active registered location. The system may update, by the computing device, the active registered location to indicate the current location.

In some embodiments, the computing device may update the active registered location automatically. Responsive to determining that the current location corresponds to the second registered location, different than the active registered location, the system may generate, by the computing device, a notification indicating that the current location corresponds to the second registered location, different than the active registered location. The system may receive, by the computing device, an input causing the computing device to update the active registered location to indicate the current location.

In some embodiments, the system may determine, by the computing device, a particular registered location of the plurality of registered locations that is an unvisited registered location. The system may generate, by the computing device, a notification indicating that the particular registered location has not been visited. The system may receive, but the computing device, an input causing the computing device to remove the particular registered locations from the plurality of registered locations. The active registered location may be updated based at least in part on the computing device connecting to a particular wireless network. The system may determine, by the computing device, that the computing device has moved to a certain proximity away from the active registered location. The system may update the active registered location to indicate the current location. The current location may be determined at least in part by network information associated with a WiFi network.

A non-transitory computer-readable memory may include instructions that, when executed by one or more processors, cause the one or more processors to perform operations. The operations may include determining, by a computing device, a current location of the computing device based at least in part on sensors of the computing device. The operations may include accessing, by the computing device, data indicating each of a plurality of registered locations and an active registered location associated with the computing device. The operations may include determining, by the computing device, that the current location corresponds to a second registered location, different than the active registered location. The operations may include updating, by the computing device, the active registered location to indicate the current location.

In some embodiments, the computing device may update the active registered location automatically. Responsive to determining that the current location corresponds to the second registered location, different than the active registered location, the operations may include generating, by the computing device, a notification indicating that the current location corresponds to the second registered location, different than the active registered location. The operations may include receiving, by the computing device, an input causing the computing device to update the active registered location to indicate the current location.

In some embodiments, the operations may include determining, by the computing device, a particular registered location of the plurality of registered locations that is an unvisited registered location. The operations may include generating, by the computing device, a notification indicating that the particular registered location has not been visited. The operations may include receiving, but the computing device, an input causing the computing device to remove the particular registered locations from the plurality of registered locations. The active registered location may be updated based at least in part on the computing device connecting to a particular wireless network. The operations may include determining, by the computing device, that the computing device has moved to a certain proximity away from the active registered location. The operations may include updating the active registered location to indicate the current location.

### BRIEF DESCRIPTION OF THE DRAWINGS

FIG. 1 illustrates an embodiment of a communication system.

FIG. 2 illustrates a system and a process for a generating a registered location, according to certain embodiments.

FIG. 3 illustrates a system for determining location data and generating a prompt, according to certain embodiments.

FIG. 4 illustrates a system for updating a registered location remotely, according to certain embodiments.

FIG. 5 illustrates a system for detecting and changing registered locations, according to certain embodiments.

FIG. 6 illustrates a flowchart of a method for updating a registered location for emergency calls, according to certain embodiments.

FIG. 7 illustrates a flowchart of a method 700 for updating of updating active registered locations for use in emergency calls, according to certain embodiments.

FIG. 8A illustrates an embodiment of a cellular network system, according to certain embodiments.

FIG. 8B illustrates an exemplary core, according to certain embodiments.

FIG. 9 illustrates an embodiment of a cellular network core network topology as implemented on a public cloud-computing platform, according to certain embodiments.

FIG. 10 depicts an example computer system according to aspects of the disclosed technology.

### DETAILED DESCRIPTION

Location information associated with a device (e.g., cellular phone) used to place an emergency call needs to be accurate so that appropriate help can be dispatched to the caller at the physical location or locations indicated by the location information. Typically, during an emergency call, location information about one or more callers needs to be readily available to an operator (e.g., a person answering the emergency call at the call center such as the public safety answering point (PSAP) or other designated call center (e.g., a state or local emergency call dispatch center) staffed with personnel that answer and process emergency calls.

Location databases can be used to store registered location information associated with the caller and/or the user device, and the registered location information in the location databases are provided or made accessible to operators of call centers that handle the emergency calls. Using the registered location information, a given operator can dispatch help to the caller in response to the emergency call.

Emergency calls can be placed by a variety of means. A cellular phone may, by default, attempt to use its home cellular network to place an emergency call. If another cellular network has a higher signal strength, this other cellular network may be used instead (e.g., in some jurisdictions, cellular networks are required to accept all emergency phone calls, regardless of whether the emergency call is placed from a device of a subscriber). In still other situations, a device may not have cellular network access, but may have access to a wireless local area network (WLAN) through which the Internet can be accessed. As an example, a computerized device can access the Internet via a WiFi network. In such situations, having a stored database of registered locations may be particularly useful to emergency dispatchers-wireless networks may tend not to move; therefore, a registered location can tend to remain accurate when the WLAN is used for an emergency call, such as compared to an emergency call placed via a cellular network.

Generally, a registered location associated with the user device is generated upon initial set up of the user device and/or in response to a user prompt. Also, a particular user device may only have a single registered location. However, many user devices are mobile-by definition the user device may be in one of many locations when an emergency call is made. The emergency call may therefore be placed from a location that is not a registered location. While using a cellular network, one or more network components of the cellular network may determine a location of the user device and provide the location to a PSAP when requested. When making an emergency call using VoWiFi, however, the same network functions may not be able to determine the location of the user device with enough specificity to direct emergency services effectively.

Furthermore, challenge exists if an emergency call is made from a location that is not the registered location, which can be referred to as a “non-registered location.” When an emergency call is made, the geographic location, which, for example, can be identified by Cartesian coordinates providing latitude, longitude, and altitude on the Earth, or X, Y, and Z coordinates, can usually be provided by the emergency caller's device. However, if the emergency call is made from a non-registered location, the call center (e.g., PSAP) may dispatch help to the registered location, where the emergency and the person placing the emergency call are not located. In addition, because the registered location and the non-registered location may correspond to different PSAP jurisdictional boundaries, routing to a PSAP based on a registered location when the caller is located in a non-registered location could result in the PSAP with appropriate jurisdiction and resources for the caller's actual location not receiving the call, which likely would lead to PSAP transfers resulting in delays and mistakes.

For example, a WiFi network may extend across a large area such as an office building using a mesh network spanning many buildings, floors, etc. A registered location of the WiFi network may therefore correspond to a location where a hub (e.g., a main router, an administrative location, etc.) of the wireless network is, or perhaps even a node of the mesh network. A user making a call via VoWiFi may not be at the same location, however, connected to some other node, on a different floor, building, etc. Existing registered location address screens may not include and/or allow for inputs of a floor or suite number. Adding the floor (e.g., 21st floor) and suite number to the registered location may save time for first responders to get to the exact location quickly rather than just having a building address with multiple floors and/or suites, apartments, etc. Thus, the registered location available to the PSAP may not accurately represent the location of the user.

Similarly, the registered location associated with the user device may not represent the location of the user. Many systems and devices may only support a single registered location for a device. Upon an initial set up of the device, the user may choose the location of the set up (e.g., the user's home) as the registered location. Continuing the example from above, the user may place an emergency call from the office building (e.g., work) over the building's WiFi mesh network. The registered location of the device therefore may be inaccurate and the PSAP may still not have access to the actual location of the user and/or the user device.

Additionally, after the emergency call is initiated, the user may move or continue to move during communication with the call center. For example, the user may move across a river, a city border or a state border, or move among floors in a building (e.g., skyscraper). In this scenario, the user may move from a registered location to a non-registered location. If the registered location is not timely updated, the emergency call may not be properly routed to the PSAP with responsibility for the area from which the person is calling and the true location of the user may not be accurately identified by the operator of the PSAP.

Furthermore, various jurisdictions worldwide require that a database of registered locations be maintained and kept accurate. A network provider (e.g., a cellular network provider, ISP) that allows for WLAN access and emergency calls may be required to maintain an up-to-date registered location database and require that the registered locations be updated when an emergency call is placed from a location that does not match the registered location.

These problems may be aggravated by certain users and/or the behavior of the certain users. For example, the user device may be configured to store multiple registered locations. The user, however, may not update the registered location as often as necessary. A user may move to a new address or location, so the registered location of the user device may need to be updated. However, the user may fail to update the registered location after moving to the new address. Together, these problems show that changes to the methods and systems used to manage registered locations of user devices may be needed. Not only may multiple registered locations per user device be needed, but the registered locations may need to be updated more often than if left solely to a user.

One solution may include configuring a user device to be associated with multiple registered locations. The user device may then receive a trigger (e.g., from an external source or generated internally) corresponding to a particular location. Based on the trigger, the user device may prompt the user to update a registered location of the user device. Upon receiving a user input, the user device may then determine a current location of the user device. The user device may then determine whether or not the current location corresponds to the particular location. If the current location and the particular location are the same, the user device may update the registered location to indicate the particular location. If the current location and the particular location are different, the user device may then generate a confirmation request, indicating the difference between the locations. If the user accepts the difference, the user device may update the registered location accordingly. If the user does not accept the difference, then the user device may generate a prompt to enter a new registered location.

As the user device moves between locations (e.g., home and work), the user device may determine a current location of the user device using one or more sensors of the user device and/or other methods. The user device may then compare the current location to one or more registered locations stored by the user device. Upon determining that the current location corresponds to one of the registered locations, the user device may then update the active registered location to indicate the current location. The user device may update the active location automatically or request a user confirmation.

“Location information,” which is indicative of the location of the device from which an emergency call is placed, can be based on global navigation satellite system (GNSS), such as the global positioning system (GPS) or Galileo system, or GLONASS system coordinates if the device has an on-board GNSS receiver (e.g., GPS receiver). For example, a smart phone or other computerized device can provide its geographic location information as two dimensional coordinates or, possibly, three dimensional coordinates if signals can be received from a sufficient number of satellites. In some embodiments, an altitude of the device may be determined using a separate component of the device, such as a barometric sensor that provides a pressure measurement. The pressure measurement can be used to determine height above ellipsoid (HAE) to estimate the device's altitude.

Location information can also involve cellular tower triangulation techniques employed by facilities-based wireless telecommunications networks. Cellular tower latitude and longitude with or without azimuth, or other horizontal location technologies such as mapped WiFi hotspots or RF identification with beacons, or some combination of these location technologies can be used for location information on the device. Another possibility is location information obtained by assisted GNSS (“A-GNSS”), of which an example is A-GPS. In A-GNSS, a communication channel is used to provide the device with data necessary to being receiving GNSS data from the GNSS satellites, thus decreasing start up time.

As used herein, “registered location information” refers to location information registered in a location database. Registered location information can include address information or other information sufficient to determine a location (e.g., a description of a location from a known landmark, coordinates). The registered location can be intended to correspond to an address at which a WLAN is installed. Therefore, if an emergency call is placed via the WLAN, if the WLAN remains installed at the same address, it can be assumed that the emergency call is originating from this same address. While “registered location information” is intended to be correct, embodiments detailed herein are used to determine whether the “registered location information” is consistent with the “current location” from which the emergency call is being placed. “current location” refers to the correct, real-world location from which the emergency call is being placed.

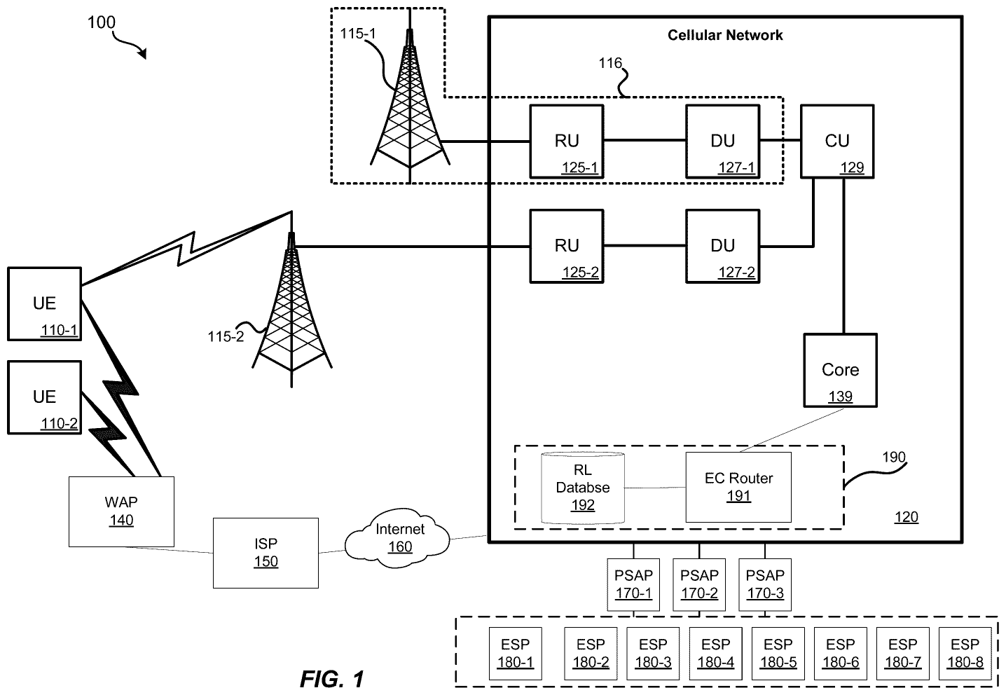

FIG. 1 illustrates an embodiment of a communication system 100 (“system 100”). System 100 can include a 5G New Radio (NR) cellular network; other types of cellular networks, such as 4G LTE, 6G, 7G, etc. are also possible. System 100 can include: UE 110 (UE 110-1, UE 110-2); base station 115; cellular network 120; radio units 125 (“RUs 125”); distributed units 127 (“DUs 127”); centralized unit 129 (“CU 129”); core 139, wireless access point (WAP) 140; internet service provider (ISP) 150, Internet 160, PSAPs 170; and emergency service providers (ESPs) 180. FIG. 1 represents a component level view. In a virtualized open radio access network (O-RAN), because components can be implemented as software in the cloud, except for components that need to receive and transmit RF, the functionality of various components can be shifted among different servers, for which the hardware may be maintained by a separate (public) cloud-service provider, to accommodate where the functionality of such components is needed.

UE 110 can represent various types of end-user devices, such as smartphones, cellular modems, tablet computers, or softphones or IOT devices, cellular-enabled computerized devices, gaming devices, or any computerized device capable of placing an emergency communication, such as to 911 in the United States. UE 110 may be capable of communicating via cellular network 120, such as smartphone 110-1 or may not be capable of communicating via cellular network 120, such as tablet computer 110-2. In the example of FIG. 1, cellular network 120 functions as the telephony provider. In other embodiments, another form of telephony system may be present, which may not include a cellular network.

UE 110 may use RF to communicate with various base stations of cellular network 120. As illustrated, two base stations 115 (BS 115-1, 115-2) are illustrated. Real-world implementations of system 100 can include many (e.g., hundreds, thousands) of base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, RUs, DUs, and CUs create a gNodeB, such as gNodeB 116, which serves as the radio access network (RAN) of cellular network 120. CU 129 can communicate with core 139. The specific architecture of cellular network 120 can vary by embodiment.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

The operator of cellular network 120 may permit UE associated with cellular network 120 to place VoIP calls via the Internet. Such an arrangement may be particularly useful to lower the volume of calls placed via the RAN of cellular network 120 and to improve coverage in areas where the RAN of cellular network 120 has a weak signal. As illustrated, smartphone 110-1 can communicate wirelessly with wireless access point 140. WAP 140 may host a wireless network, such as a WiFi network, through which smartphone 110-1 may use various protocols such as TCP/IP to communicate with remote computing systems via Internet 160. When placing a call, UE 110 may communicate with cellular network 120 (or some other VolP provider) via WAP 140, ISP 150, and Internet 160. In some embodiments, ISP 150 may be cellular network 120. For example, a 5G modem may be connected with or integrated with WAP 140 to allow Internet access and VoIP calling via WAP 140 to various computerized devices.

When an emergency call is placed using a cellular device, such as smartphone 110-1, the default may be to use any available cellular network having sufficient signal strength. Therefore, VolP may be avoided and a cellular call may be placed via cellular network 120. However, in some circumstances, all cellular networks, including cellular network 120, may not be reachable for an emergency call. In such a situation, VolP via WAP 140 may be used by both cellular enabled devices, such as smartphone 110-1, and non-cellular devices, such as tablet computer 110-2.

For such a VoIP-based emergency call, the emergency call may be routed via WAP 140, ISP 150, and Internet 160 to the entity hosting the emergency call, which is in this case cellular network 120. Cellular network 120, either as part of the cellular network or accessible externally, may have an emergency call routing system 190. In some embodiments, emergency call routing system 190 may reside outside of cellular network 120 and be maintained by a separate entity. Emergency call routing system 190 serves to: 1) ensure that a received emergency call is routed to the appropriate PSAP; and 2) maintain an up-to-date registered location database.

When a VoIP-based emergency call is received, the emergency call can be routed to emergency call (EC) router 191 of emergency call routing system 190. EC router 191 may compare location information associated with the VoIP-based emergency call with registered location data stored for UE 110 or WAP 140 from which the call was received. The location of the UE may be determined based on a PIDF-LO (Presence Information Data Format Location Object) message being transmitted. For emergency calls, PIDF-LO allows for location information to be transmitted as part of the session invitation protocol (SIP) invite message. As previously detailed, the location information used for the PIDF-LO tag may be obtained using GNSS measurements, barometric measurements, or sources, or some combination thereof by UE 110.

Upon receipt of the SIP invite message, the location information from the PIDF-LO tag may be extracted and compared to the associated registered location stored in registered location (RL) database 192. A threshold distance can be used to determine whether the registered location information matches the location data received from the UE. For example, the threshold distance could be 50 meters. In this example, if the registered location is less than 50 meters from the location indicated by the location information, the user may be determined to be at the registered location; if more than 50 meters away, the user may be determined to be at a new location. To be clear, the threshold distance can factor in all three dimensions; therefore, altitude is factored in when determining whether within the threshold distance. In other embodiments, the threshold distance is between 10 and 100 meters. Location data within RL database 192 may be stored as an address or coordinates. An address may be easily converted into coordinates using various mapping systems; similarly, coordinates can be converted into an address using similar mapping systems.

EC router 190 can use the location information and/or registered location information to determine the proper PSAP of PSAPs 170 to which the emergency call should be routed. As illustrated three PSAPs 170 are illustrated by way of example only. A large number of PSAPs can exist nationwide and worldwide. When the call is routed to a PSAP, information may be included indicating that the registered location does or does not match the location data obtained from the PIDF-LO tag. The PSAP may also be provided with the location information obtained from the PIDF-LO tag. The PSAP handling the call may then determine whether to dispatch, and which emergency service provider (ESP) should be dispatched. As illustrated, eight ESPs 180 are present. The true number of available ESPs nationwide and worldwide are much greater. For example, an ESP of ESPs 180 may be: a city's fire department, the state police, the coast guard, a county's sheriff department, a town's volunteer ambulance department, etc.

When the registered location is determined by EC router 191 to match the location information received in the PIDF-LO tag, no additional action may need to be taken by EC router 191. However, when the registered location is determined by EC router 191 to not match the location information received in the PIDF-LO tag within a defined threshold distance, additional action may need to be taken. Some jurisdictions, such as the United States, require that an opportunity be provided for the registered location to be updated, even while the emergency call is ongoing.

Therefore, in some embodiments, while the emergency call is ongoing, EC router 191 (or another component of cellular network 120) may cause data to be transmitted to the UE from which the emergency call originated that requests that the user update the registered location.

Various mechanisms may be used to prompt a user to update the registered location. In a first set of embodiments, a wireless application protocol (WAP) message may be sent to the UE. The WAP message is a form of short message service (SMS) message in which a header of the SMS message links to a WAP address. Upon receiving the WAP message, the UE gives the end user the option to access the WAP content linked by the WAP address. At the user's discretion, upon selecting the option, the user could be presented with an interface (e.g., webpage) through which the registered address can be updated. If the user updates the address, the registered location stored by RL database 192 is updated.

In a second set of embodiments, an SMS message (or MMS message) may be used. The SMS message may be sent to the phone that includes a message that asks the user to access a link to update their registered location. The user may then, at the user's discretion, access the link and perform the update. If the user updates the address, the registered location stored by RL database 192 is updated.

In a third set of embodiments, messaging may be performed using an alternate arrangement, such as via TCP/IP and HTTP. The UE may be able to be otherwise triggered to access a particular webpage or present content to the user that gives the user, at the user's discretion, the ability to update the registered location. If the user updates the address, the registered location stored by RL database 192 is updated.

In a fourth set of embodiments, the registered location may be updated automatically. In such embodiments, the data from the PIDF-LO tag may be either stored as coordinates or converted to an address for storage in RL database 192. Occasionally or periodically (e.g., every 10 seconds, 15 seconds, 30 seconds), while the VoIP emergency call is ongoing, the UE that originated the emergency call may be triggered to send a refreshed PIDF-LO tag. Such messages can capture movement of the UE since the emergency call began. Such arrangement may be particularly beneficial if the WLAN through which the VolP emergency call is made is present on a vehicle, such as a commuter bus or even a personal vehicle.

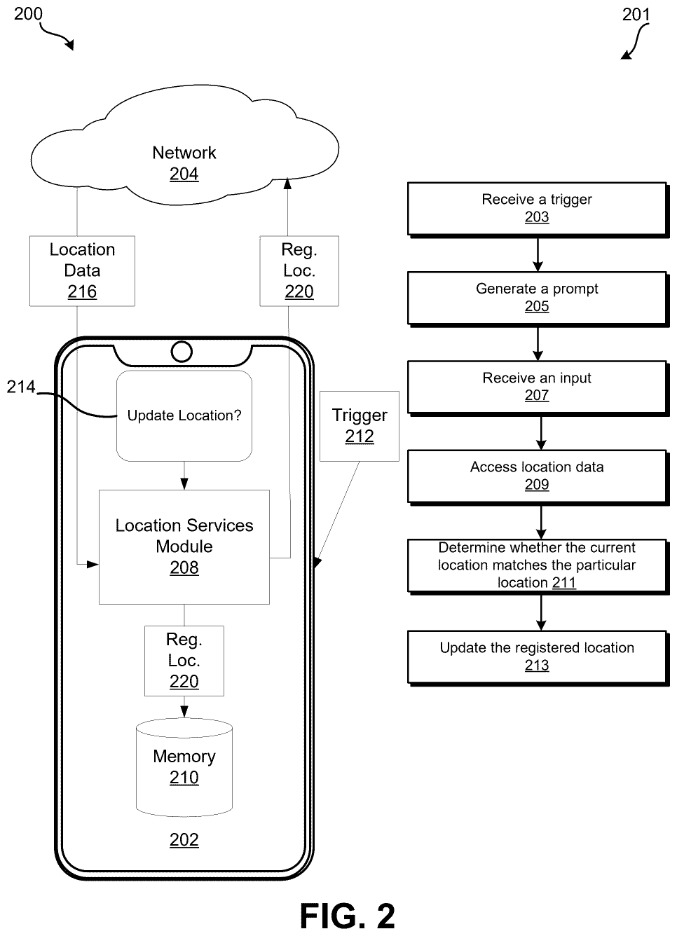

FIG. 2 illustrates a system 200 and a process 201 for a generating a registered location, according to certain embodiments. The system 200 may include a user equipment (UE) 202 and a network 204. The UE 202 may also include a location services module (LSM) 208 and a memory 210. The UE 202 may be a mobile device such as a smartphone, cell phone, wearable mobile device, tablet, laptop computer, or any other such device. Although not shown in FIG. 2, the UE 202 may include one or more wireless circuitries configured to communicate via one or more wireless protocols such as Bluetooth, WiFi, Zigbee, or any other suitable wireless communication protocol.

The UE 202 may be associated with a cellular network provider that provides the network 204. The network 204 may be similar to some or all of the system 100 in FIG. 1. The cellular network provider may provide a 5G network, configured to provide voice and/or data services such as VoWiFi. Thus, the network 204 may be one or more networks, such as a WLAN, 5G cellular network, and other networks working independently and/or in conjunction with one another.

The LSM 208 may include one or more hardware and/or software components configured to determine and manage registered locations for the UE 202. The LSM 208 may determine various locations of the UE 202 by accessing other components of the UE 202. For example, the LSM 208 may determine various WLANs that the UE 202 connects to by accessing one or more of the wireless circuitires of the UE 202. A first WLAN may be associated with a user's (of the UE 202) home. The LSM 208 may then determine a first registered location associated with the first WLAN. Similarly, the LSM 208 may determine a second registered location associated with a second WLAN in workplace of the user. The LSM 208 may additionally or alternatively access one or more sensors (e.g., a gyroscope, a GPS service, barometer, etc.). of the UE 202 to determine a location of the UE. The LSM 208 may store locations of the UE 202 and determine one or more locations that may be registered locations based on frequency, time spent at each location, or other such characteristics.

The LSM 208 may also be connected to a memory 210. The memory 210 may be a physical and/or logical memory segment for storing registered locations associated with the UE 202. The memory 210 may therefore include a list of current and/or past registered locations. The LSM 208 may cause one or more entries in the list to be generated and removed based on certain criteria. In some embodiments, the LSM 208 may maintain each registered location in the list until removed by a command (e.g., a user input). In some embodiments, the LSM 208 may maintain each registered location in the list for a given time period (e.g., 1 month, d6 months, etc.). At the expiry of the time period, the LSM 208 may generate a prompt for the user to remove or keep the registered location. One of ordinary skill in the art would recognize many different possibilities.

At 203, the UE 202 may receive a trigger 212 to update a registered location of the UE 202. The trigger 212 may indicate location information of the UE 202. The trigger 212 may be generated internally by some component of the UE 202, or by an external trigger received by the UE 202. For example, the trigger 212 may be generated by the UE 202 in response to an initial setup process (e.g., when the UE 202 is first powered on and connected to the network 204). Additionally or alternatively, the trigger 212 may be generated in response to the LSM 208 determining that a current location is often visited by the UE 202. If, as an example, the LSM 208 determines that the UE 202 connects to the network 204 via a particular WLAN. The particular WLAN may be associated with a location that is not a registered location associated with the UE 202. The LSM 208 may therefore generate the trigger 212 to update and/or add the location as a registered location.

In another example, the trigger 212 may be generated by a service of the network 204. For example, the UE 202 may be associated with a user that is part of a larger account. An administrator of the larger account may have knowledge that the user has recently changed residences (or workplaces, etc.). The administrator may then cause the service to generate the trigger 212, prompting the user to update or add a registered location.

At 205, the LSM 208 (and/or another module of the UE 202) may generate a prompt 214 for display by the UE 202. The prompt 214 may be automatically populated with some or all of the location information determined and/or indicated by the trigger 212. For example, the location indicated in the trigger 212 may be associated with an apartment building. The location may therefore include a street address, GPS coordinates, and/or other such information. The registered location may be a physical address (e.g., a street address). However, the UE 202 may not be able to determine specifics, such as a floor of the apartment building and/or a unit number. Thus, the prompt 214 may display the street address and provide inputs for the user to enter a z-axis (e.g., a floor number) and other specific information (e.g., a unit number). The prompt 214 may also include an input through which the user can indicate a desire to update a registered location of the UE 202.

At 207, the LSM 208 may receive an input indicating that the user of the UE 202 wishes to update the registered location. As described above, the user may indicate location specifics such as a z-axis of the location. Then, the user may indicate that the location displayed in the prompt 214 is to be a registered location. The user may indicate that the location should replace a registered location and/or be added as an additional registered location.

At 209, in response to the input, the LSM 208 may access location data 216 indicating a current location of the UE 202. The location data 216 may be accessed from a WLAN, the network 204, via sensors of the UE 202, or any other suitable method. Then, at 211, the LSM 208 may determine whether or not the current location indicated by the location data 209 corresponds to the location indicated in the prompt 214. For example, the trigger 212 may be received from the service of the network 204 and indicate a first location. The prompt 214 may therefore indicate the first location as well. The first location may be a residence of the user (or some other location associated with the user). The user may then provide an input via the prompt 214 indicating that the first location should be a registered location. The LSM 208 may then access location data. The location data, however, may indicate that the current location of the UE 202 is not the same as the first location. Then, the LSM 208 may generate a second prompt, confirming that the first location should be a registered location and not the first location. In another example, the trigger 212 may be generated as part of an initial set up. Then, the location indicated in the prompt 214 may be determined by the LSM 208. The user may indicate that the location indicated in the prompt 214 is to be a registered location.

At 213, the LSM 208 may update a registered location to be the location indicated in the prompt 214 (or as otherwise entered in a confirmation prompt). The LSM 208 may cause a registered location 220 to be generated and stored in the memory 210. The registered location 220 may be the only registered location associated of the UE 202, or may be on of a plurality of registered locations associated with the UE 202. Additionally or alternatively, the registered location 220 may be transmitted to one or more network functions of the network 204. For example, the network 204 may cause the registered location 220 to be stored in a database and associated with the UE 202. If the UE 202 subsequently places an emergency call, network functions of the network 204 may transmit the registered location 220 to the PSAP and/or other networks, as appropriate.

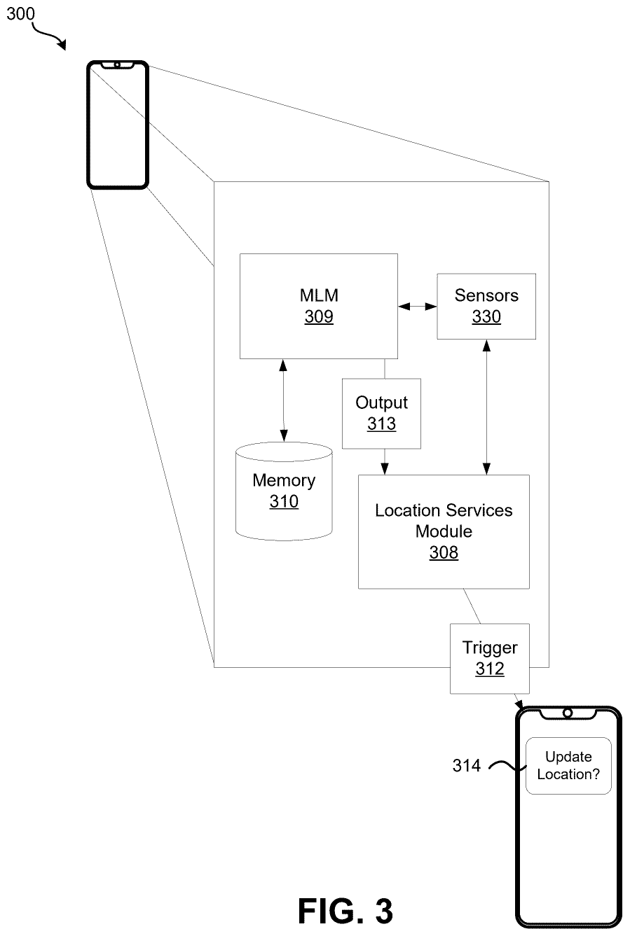

FIG. 3 illustrates a system 300 for determining location data and generating a prompt 314, according to certain embodiments. The system 300 may be similar to all or some of the system 200 in FIG. 2. The system 300 may also work in conjunction with some or all of the system 100 in FIG. 1. The system 300 may include a UE 302 with an LSM 308, a machine learning module (MLM) 309, a memory 310, and sensors 330. The UE 302 may be a mobile device such as a smartphone, cell phone, wearable mobile device, tablet, laptop computer, or any other such device. Although not shown in FIG. 2, the UE 302 may include one or more wireless circuitries configured to communicate via one or more wireless protocols such as Bluetooth, WiFi, Zigbee, or any other suitable wireless communication protocol.

The LSM 308 may be similar to the LSM 208 in FIG. 2, and include similar component and functionalities. The LSM 308 may also include the MLM 309, or the MLM 309 may be a separate component (as shown in FIG. 3). In some embodiments, the MLM 309 may be included in a network-based resource (e.g., a cloud resource) that is accessible to the UE 202. The MLM 309 may include one or more machine learning models and/or rules based filters trained to identify likely candidates for registered locations of the UE 202. The MLM 309 may therefore include models such as a K-nearest neighbor model, clustering algorithms, binary classification models, and other suitable machine learning models.

The MLM 309 may access location data from the sensors 330 and/or other data (e.g., data from a network, stored data, etc.). The MLM 309 may access GPS data from a GPS module of the sensors 330. The MLM 309 may also access time data (e.g., a date and time) from one or more clocks etc. The MLM 309 may utilize the location data and/or other data to determine likely candidate locations for registered locations. For example, the MLM 309 may determine that the UE 302 is in a given location for 10 hours five days a week. The MLM 309 may also determine that the given location is not included in the memory 310. The MLM 309 may therefore generate an output 313 that indicates that the given location is likely to be a candidate location for a registered location of the UE 302. The MLM 309 may then provide the output 303 to the LSM 308. In response, the LSM 308 may generate a trigger 312 (similar to the trigger 212) and/or the prompt 314 (similar to the prompt 214). Thus, the prompt 314 may indicate the given location and provide a user of the UE 302 an input to include the given location as a registered location.

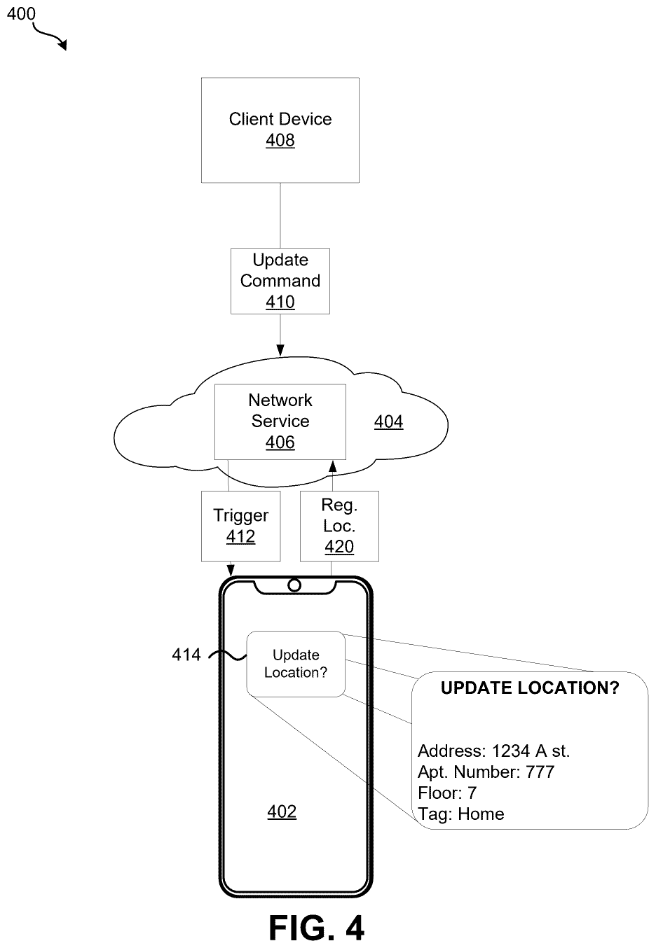

FIG. 4 illustrates a system 400 for updating a registered location remotely, according to certain embodiments. The system 400 may include a UE 402, and a network 404. The UE 402 may be similar to the UE 202 and the UE 302 in FIGS. 2 and 3, respectively. The UE 402 may therefore include similar components and capabilities, even if not shown in FIG. 4. For example, the UE 402 may include an LSM, a memory, sensors, and other components. Thus, the UE 402 may generate an update prompt 414, prompting a user to update and/or add a registered location.

The network 404 may include a network service 406. The network service 406 may include one or more hardware and/or software components configured to manage registered location operations for a network provider (of the network 404). The network service 406 may provide a portal through which account administrators may perform various functions associated with registered locations for the UE 402 (and other UEs). For example, the UE 402 may be a member device of an account having multiple users and/or UEs. A client device 408 may be associated with an administrator of the account. The client device 408 may then access the network service 406 via an application, an application programming interface (API), or other such. The client device 408 may transmit an update command 410 to the network service 406 of the network 404. The update command 410 may include address information such as a street address, floor, apartment number, etc. as well as other information such as a tag (e.g., “home,” “work,” etc. The update command 410 may also identify the UE 402 as a member device of the account and/or a relationship between the client device 408 and the UE 402 (or users thereof) such as an administrator, a parent, etc.

The network service 406 may then determine that the location indicated in the update command 410 is not a registered location of the UE 402 (e.g., by accessing a database). The network service 406 may then generate and transmit a trigger 412 to the UE 402. The trigger 412 may indicate the location and/or other information included in the update command. The UE 402 may utilize some or all of the information included in the trigger 412 to generate and display the update prompt 414. Some or all of the information in the update prompt 414 may be automatically generated. For example, if the client device 408 is an administrator of the account, all of the address information may be automatically generated.

The user of the UE 402 may thereby accept and/or modify some or all of the information included in the trigger 412. For example, the update prompt 414 may provide an input for the user to update a floor of the address (e.g., in an apartment building), a tag (e.g., home), and other information. The user may then accept the information in the update prompt 414 and cause the location to be added as a registered location 420. The UE 402 may verify that the location matches a current location (as described in relation to FIG. 2). The UE 402 may store the registered location 420 in a memory on the UE 402 and/or transmit the registered location 420 to the network service 406.

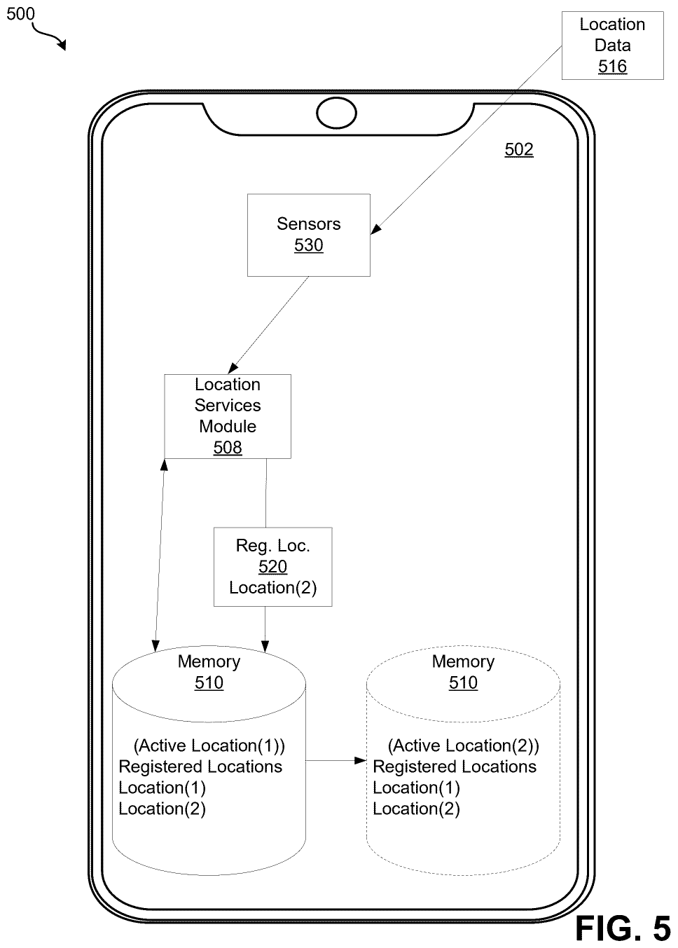

FIG. 5 illustrates a system 500 for detecting and changing registered locations, according to certain embodiments. The system 500 may be similar to the systems 200-400 in FIGS. 2-4, respectively. The system 500 may include a UE 502. The UE 502 may include an LSM 508, a memory 510, and sensors 530. The LSM 508 may be similar to the LSM 208 and 308 in FIGS. 2-3. The LSM 508 may include one or more hardware and/or software components configured to determine and manage registered locations for the UE 202. The LSM 508 may determine various locations of the UE 502 by accessing other components of the UE 502. For example, the LSM 508 may determine various WLANs that the UE 502 connects to by accessing one or more of the wireless circuitries of the UE 502. The LSM 508 may also include an MLM similar to the MLM 309 in FIG. 3, including one or more machine learning models and/or rules-based filters.

The memory 510 may be similar to the memory 210 and include similar features and functionalities. As seen in FIG. 5, the memory 510 may include a list indicating a plurality of registered locations (here, Location(1) and Location(2)). The memory 510 may also include data indicating an active registered location. The active registered location may be the registered location to be used in the event of an emergency call. In other words, the active registered location may be provided to the PSAP during the emergency call. In traditional systems, only one registered location may be associated with the UE 502. Therefore, there may be no need to indicate an active registered location, as the UE would only have one registered location. However, if the UE 502 was in some other location, the UE 502 may not be able to provide the registered location to the PSAP or another necessary party. With a plurality of registered locations, the UE 502 may be able to provide an accurate location to the PSAP.

To determine which registered location to use, the UE 502 may obtain location data 516 via the sensors 530 (similar to the sensors 230 in FIG. 2). The location data 516 may indicate a current location of the UE 502. The location data 516 may additionally or alternatively include network information associated with a connected network (e.g., the network 204 in FIG. 2). The network information may include a network name, a registered location of the network (e.g., a main node, administrator's location etc.), and other such information. In some embodiments, the network information may include a device location obtained via one or more wireless transceivers of the connected network and transmitted to the UE 502 (e.g., via WiFi sensing).

The LSM 508 may then access the memory 510 to determine whether the location data 516 corresponds to a registered location. The location data 516 may indicate that the UE 502 is within a threshold of the Location(2), even though the active registered location is currently Location(1). The threshold may be a distance such as 10 m, 15 m, 50 m, 100 m, etc. If the location data 516 indicates that the UE 502 is outside of the threshold, then the UE 502 may not prompt the user to update the registered location to indicate Location(2). If, however, the location data 516 indicates that the UE 502 is within the threshold, the UE 502 may generate a registered location prompt (e.g., the prompt 414 in FIG. 4). Then, the user may indicate via the prompt that the registered location 520 should be updated to Location(2), as seen in FIG. 2.

Additionally or alternatively, the LSM 508 may automatically update the active registered location. For example, according to a user setting, the LSM 508 may detect an active registered location based at least in part on the location data 516. Then, the LSM 508 may cause the memory 510 to indicate the detected active registered location. The LSM 508 may also generate and display a notification on the UE 502 indicating that the registered location has been updated.

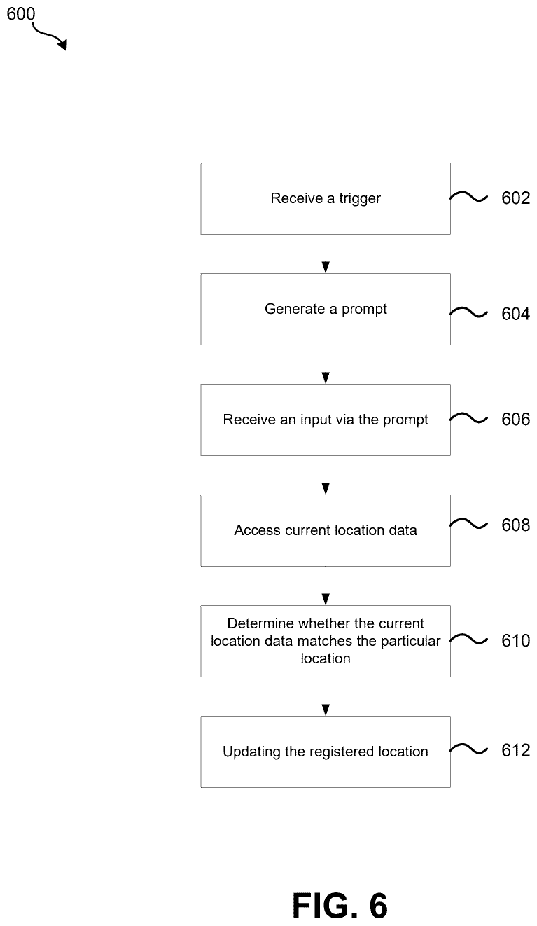

FIG. 6 illustrates a flowchart of a method 600 for updating a registered location for emergency calls, according to certain embodiments. The method 600 may be performed by the systems 100-500 in FIGS. 1-5, independently and/or in conjunction with one another. The steps of the method 600 may be performed in a different order than is shown and/or combined with other steps. In some embodiments, some steps may be skipped altogether.

At 602, the method 600 may include receiving, by a computing device, a trigger corresponding to a particular location. The computing device may be similar to the UE 202, 302, 402, and/or 502. The computing device may be a mobile device such as a smartphone, cell phone, wearable mobile device, tablet, laptop computer, or any other such device. The computing device may include one or more wireless circuitries configured to communicate via one or more wireless protocols such as Bluetooth, WiFi, Zigbee, or any other suitable wireless communication protocol. The computing device may be configured to provide VoIP calls using WiFi networks, cellular networks and other appropriate networks. The cellular networks may be a 5G network, implemented using an open radio access network (ORAN) and a cloud-based architecture.

In some embodiments, the trigger may be generated by the computing device. The computing device may determine a plurality of location data. The plurality of location data may be provided to a machine learning model (e.g., the MLM 309 in FIG. 3). The machine learning model may be trained, at least in part, to determine one or more candidate locations from the plurality of location data. The machine learning model may assign a score to each candidate location, indicating a likelihood that the candidate location should be a registered location. The computing device may then receive an output indicating the one or more candidate locations. If the respective score of a candidate location is above a pre-determined threshold, the computing device may generate the trigger. In some embodiments, the trigger may be generated in response to an external signal. For example, a network service (e.g., the network service 406) may transmit the trigger to the computing device in response to an update command (as is described in FIG. 4). In some embodiments, the trigger may correspond to a user input and/or a first-time connection of the computing device to a WiFi network. In some embodiments, the trigger may be generated according to a pre-determined time period (e.g., to confirm the registered location(s)).

At 604, the method 600 may include generating, by the computing device, a prompt to update a registered location for display by the computing device. The prompt may be similar to the prompt 314 in FIG. 3 and or the prompt 414 in FIG. 4. The prompt may therefore include an address, a floor or level, a unit number (e.g., an apartment number), a tag, and other such information. The prompt may also include features or elements that allow a user to add or modify the information displayed in the prompt. The prompt may also include an element to indicate whether or not the displayed registered location should be designated a registered location.

At step 606, the method 600 may include receiving, by the computing device, an input via the prompt. The input may indicate that the registered location is to be updated to include the particular location. For example, the particular location may be provided by an external party (e.g., see FIG. 4). The user may confirm some or all of the information displayed in the prompt, and provide an input to update the registered location(s) to include the particular location. Alternatively, the user may modify some or all of the information and then provide the input to include the modified particular location as registered location.

At step 608, the method 600 may include accessing, by the computing device, current location data associated with the computing device. The computing device may determine the location data using one or more sensors included in the computing device (e.g., a GPS module, barometers, etc.) and/or network data from a connected network (e.g., a network location, a network name, etc.).

At step 610, the method 600 may include determining, by the computing device, whether or not the current location data corresponds to the particular location. For example, the prompt may include information about the particular location. The computing device may compare the current location data to the information indicating the particular location, and determine that the current location and the particular location are the same. Then, at 612, the method may include updating, by the computing device, the registered location such that the particular location is the registered location. In some embodiments, the computing device may include a plurality of registered locations. The particular location may then be added to the plurality of registered locations. For example, the computing device may access a memory (e.g., the memory 510 in FIG. 5) that includes a list of registered locations associated with the computing device. The computing device may determine that the current location data indicates a new location, not represented on the list.

In some embodiments, the particular location may differ from the current location. The user may indicate that the particular location is to be a registered location, but location data indicated by the computing device may correspond to an alternate or different location. Then, the method 600 may include generating, by the computing device, a confirmation notification indicating that the current location does not correspond to the particular location. The method 600 may also include displaying, by the computing device, the confirmation notification.

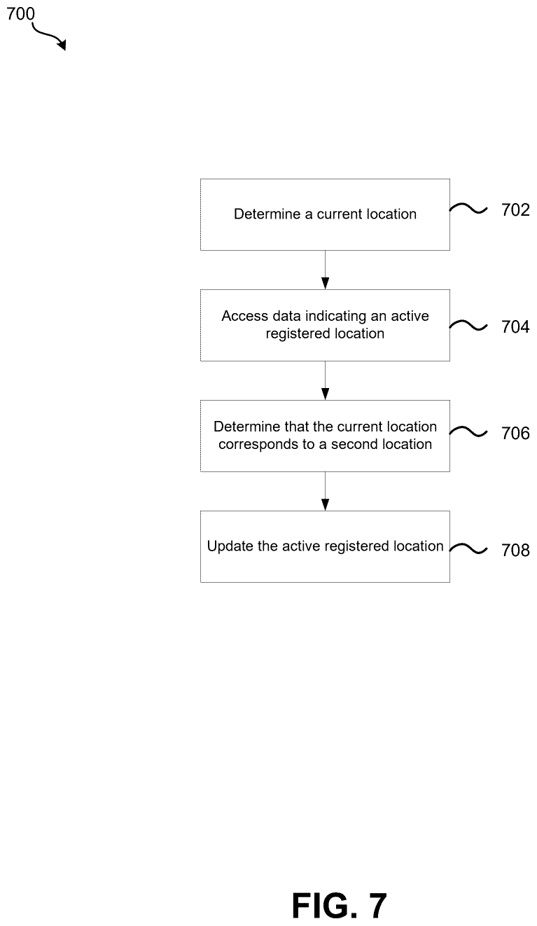

FIG. 7 illustrates a flowchart of a method 700 for updating of updating active registered locations for use in emergency calls, according to certain embodiments. The method 700 may be performed by the systems 100-500 in FIGS. 1-5, independently and/or in conjunction with one another. The steps of the method 700 may be performed in a different order than is shown and/or combined with other steps. In some embodiments, some steps may be skipped altogether.

At 702, the method may include determining, by a computing device, a current location of the user device based at least in part on sensors of the user device. The computing device may be similar to the UE 202, 302, 402, and/or 502. The computing device may be a mobile device such as a smartphone, cell phone, wearable mobile device, tablet, laptop computer, or any other such device. The computing device may include one or more wireless circuitries configured to communicate via one or more wireless protocols such as Bluetooth, WiFi, Zigbee, or any other suitable wireless communication protocol. The computing device may be configured to provide VOIP calls using WiFi networks, cellular networks and other appropriate networks. The cellular networks may be a 5G network, implemented using an open radio access network (ORAN) and a cloud-based architecture. The computing device may also include sensors such as a GPS module, a barometer, a compass, and other such sensors.

At 704, the method may include determining, by the computing device, accessing, by the computing device, data indicating each of the plurality of registered locations and an active registered location associated with the computing device. As shown in FIG. 5, the computing device may be associated with a plurality of registered locations. Each of the registered locations may be associated with the computing device (e.g., a home location, work location, etc.). A list of the registered locations may be stored on the computing device and/or externally (e.g., in a cloud service of a network provider). The active registered location may be determined automatically by the computing device and/or in response to a user input.

At step 706, the method 700 may include determining, by the computing device, that the current location corresponds to a second registered location, different than the active registered location. For example, the current location may be within a certain proximity of the second registered location and/or a certain distance away from the active registered location. Then, the computing system may generate a prompt (e.g., the prompt 514) to update the active registered location to indicate the current location. In some embodiments, the computing system may automatically update the active registered location.

At 708, the method 700 may include updating, by the computing device, the active registered location to indicate the current location. In some embodiments, the current location may correspond to a registered location of the plurality of registered locations. In some embodiments, the current location may be a new location and be added to the plurality of registered locations.

In some embodiments, responsive to determining that the current location corresponds to the second registered location, different than the active registered location, the method 700 may include generating, by the computing device, a notification indicating that the current location corresponds to the second registered location, different than the active registered location. The notification may be a prompt (e.g., the prompt 514) and/or a confirmation prompt. The method 700 may also include receiving, by the computing device, an input causing the computing device to update the active registered location to indicate the current location.

In some embodiments, the method 700 may include determining, by the computing device, a particular registered location of the plurality of registered locations that is an unvisited registered location (e.g., has not been visited for a pre-determined amount of time). The method 700 may then include generating, by the computing device, a notification indicating that the particular registered location has not been visited. The method 700 may then include receiving, but the computing device, an input causing the computing device to remove the particular registered locations from the plurality of registered locations.

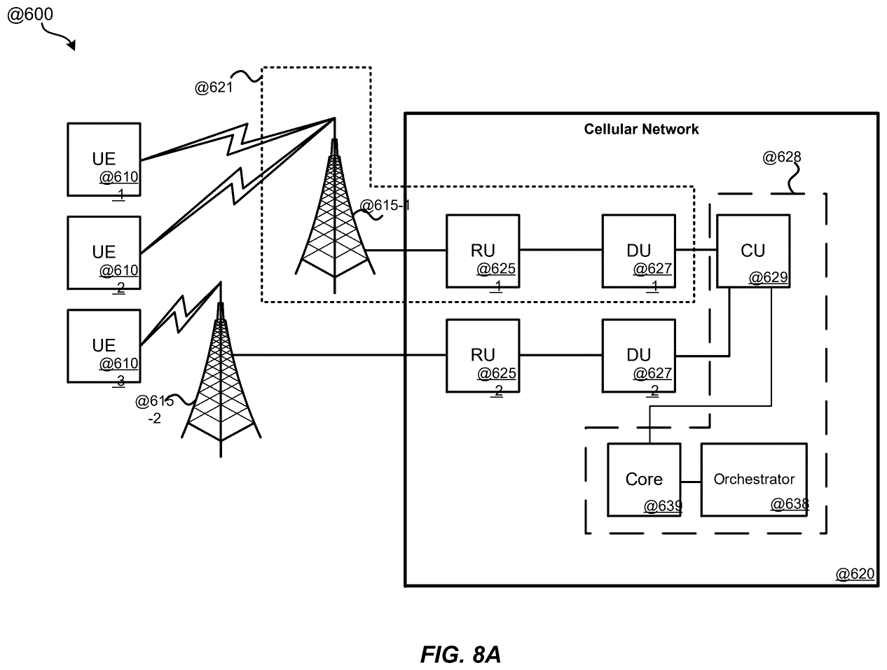

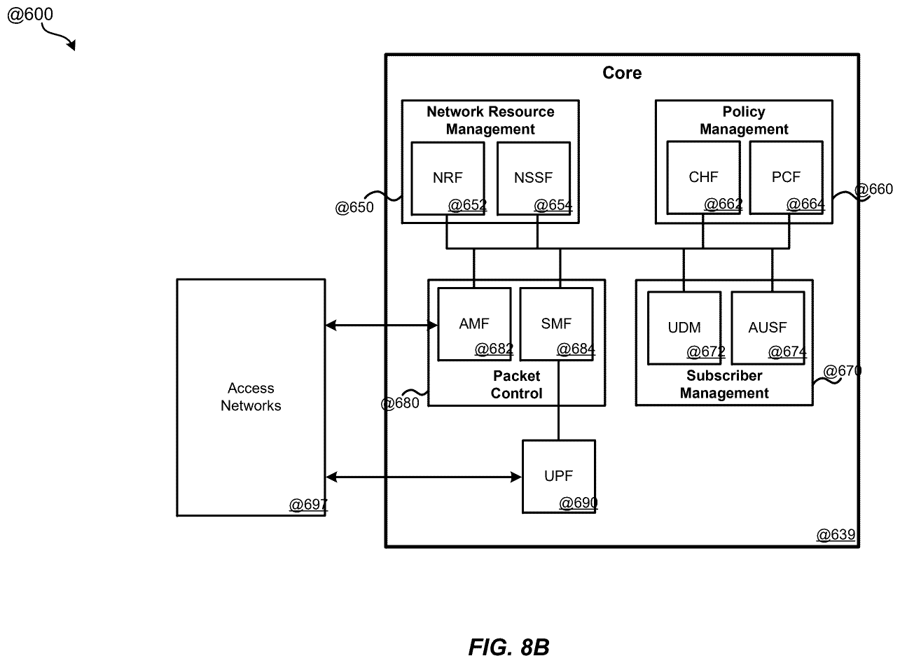

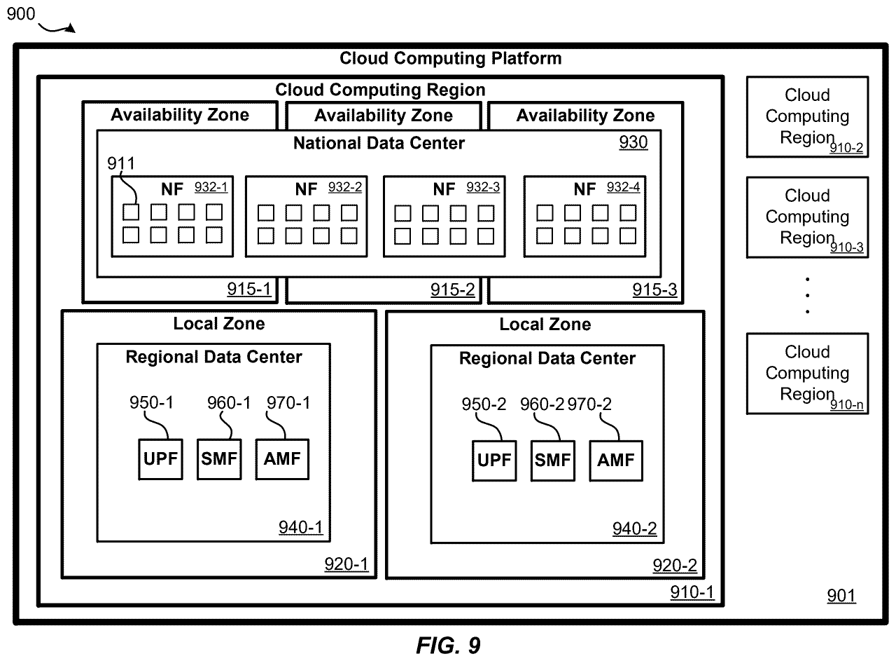

FIG. 8A illustrates an embodiment of a cellular network system 800 (“system 800”), according to certain embodiments. System 800 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 800 can include: UE 810 (UE 810-1, UE 810-2, UE 810-3); base station 815; cellular network 820; radio units 825 (“RUs 825”); distributed units 827 (“DUs 827”); centralized unit 829 (“CU 829”); core 839, and orchestrator 838. FIG. 8A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 9.

UE 810 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 810 may use RF to communicate with various base stations of cellular network 820. Two base stations 815 (BS 815-1, 815-2) are illustrated. Real-world implementations of system 800 can include many (e.g., hundreds, thousands) base stations, and many RUs, DUs, and CUs. BS 815 can include one or more antennas that allow RUs 825 to communicate wirelessly with UEs 810. RUs 825 can represent an edge of cellular network 820 where data is transitioned to wireless communication. In some implementations, the radio access technology (RAT) used by RU 825 is 5G New Radio (NR). Other implementations use other RAT, such as 4G Long Term Evolution (LTE). The remainder of cellular network 820 may be based on an exclusive 5G architecture, a hybrid 4G/5G architecture, a 4G architecture, or some other cellular network architecture. Base station equipment 821 may include an RU (e.g., RU 825-1) and a DU (e.g., DU 827-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 825-1, may communicate with DU 827-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 827-1, may communicate with CU 829. Collectively, RUs, DUs, and CUs create a gNodeB, which serves as the radio access network (RAN) of cellular network 820. CU 829 can communicate with core 839. The specific architecture of cellular network 820 can vary by embodiment. Edge cloud server systems outside of cellular network 820 may communicate, either directly, via the Internet, or via some other network, with components of cellular network 820. For example, one or more DUs 827-1 may be able to communicate with an edge cloud server system without routing data through CU 829 or core 839.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 839 is provided in relation to FIG. 8B. FIG. 8B illustrates an exemplary core 839, according to certain embodiments. The exemplary core 839 can be physically distributed across data centers or located at a central national data center (NDC), such as detailed in relation to FIG. 9, can perform various core functions of the cellular network. Core 839 can include: network resource management components 850; policy management components 860; subscriber management components 870; and packet control components 880. Individual components may communicate via a bus, thus allowing various components of core 839 to communicate with each other directly. Core 839 is simplified to show some key components. Implementations can involve additional components.

Network resource management components 850 can include: Network Repository Function (NRF) 852 and Network Slice Selection Function (NSSF) 854. NRF 852 can allow 5G network functions (NFs) to register and discover each other via a standards-based application programming interface (API). NSSF 854 can be used by AMF 882 to assist with the selection of a network slice that will serve a particular UE (e.g., UEs 810 of FIG. 8A).

Policy management components 860 can include: Charging Function (CHF) 862 and Policy Control Function (PCF) 864. CHF 862 allows charging services to be offered to authorized network functions. Converged online and offline charging can be supported. PCF 864 allows for policy control functions and the related 5G signaling interfaces to be supported.

Subscriber management components 870 can include: Unified Data Management (UDM) 872 and Authentication Server Function (AUSF) 874. UDM 872 can allow for generation of authentication vectors, user identification handling, NF registration management, and retrieval of UE individual subscription data for slice selection. AUSF 874 performs authentication with UEs.

Packet control components 880 can include: Access and Mobility Management Function (AMF) 882 and Session Management Function (SMF) 884. AMF 882 can receive connection- and session-related information from UEs and is responsible for handling connection and mobility management tasks. SMF 884 is responsible for interacting with the decoupled data plane, creating updating and removing Protocol Data Unit (PDU) sessions, and managing session context with the User Plane Function (UPF).

User plane function (UPF) 890 can be responsible for packet routing and forwarding, packet inspection, quality of service (QoS) handling, and external PDU sessions for interconnecting with a Data Network (DN) (e.g., the Internet) or various access networks 897. Access networks 897 can include the RAN of cellular network 820 of FIG. 8A.

While FIGS. 8A and 8B illustrate various components of cellular network 820, it should be understood that other embodiments of cellular network 820 can vary the arrangement, communication paths, and specific components of cellular network 820. While RU 825 may include specialized radio access componentry to enable wireless communication with UE 810, other components of cellular network 820 may be implemented using either specialized hardware, specialized firmware, and/or specialized software executed on a general-purpose server system. In a virtualized arrangement, specialized software on general-purpose hardware may be used to perform the functions of components such as DU 827, CU 829, and core 839. Functionality of such components can be co-located or located at disparate physical server systems. For example, certain components of core 839 may be co-located with components of CU 829.

Returning to FIG. 8A, some O-RAN implementations of the DUs 827, CU 829, core 839, and/or orchestrator 838 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 800, cloud-based cellular network components A128 include CU 829, core 839, and orchestrator 838. In some embodiments, DUs 827 may be partially or fully added to cloud-based cellular network components 828. Such cloud-based cellular network components 828 may be executed as specialized software executed by underlying general-purpose computer servers. Cloud-based cellular network components 828 may be executed on a public third-party cloud-based computing platform or a cloud-based computing platform operated by the same entity that operates the RAN. A cloud-based computing platform may have the ability to devote additional hardware resources to cloud-based cellular network components 828 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 820 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 838. Orchestrator 838 can represent various software processes executed by underlying computer hardware. Orchestrator 838 can monitor cellular network 820 and determine the amount and location at which cellular network functions should be deployed to meet or attempt to meet service level agreements (SLAs) across slices of the cellular network.

Orchestrator 838 can allow for the instantiation of new cloud-based components of cellular network 820. As an example, to instantiate a new DU, orchestrator 838 can perform a pipeline of calling the DU code from a software repository incorporated as part of, or separate from, cellular network 820; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 820. Cellular network 820 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 825-1 and DU 827-1; and a second set of network slices, which may only partially overlap or may be wholly different from the first set, may be reserved at RU 825-2 and DU 827-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 8A, UE 810 may be operating on one or more production slices of cellular network 820. As detailed later in this document, a UE that functions on a particular entity's local network may be assigned to a slice particular to the entity or a slice that provides a particular QoE for tasks to be performed by the entity's UE.

Components such as DUs 827, CU 829, orchestrator 838, and core 839 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 9 illustrates an embodiment of a cellular network core network topology 900 as implemented on a public cloud-computing platform, according to certain embodiments. The cellular network core network topology 900 can be an implementation of the core 839 of FIG. 8A and/or 8B. Cellular network core network topology 900 can represent how logical cellular network groups are distributed across cloud computing infrastructure of cloud computing platform 901. Cloud computing platform 901 can be logically and physically divided up into various different cloud computing regions 910. Each of cloud computing regions 910 can be isolated from other cloud computing regions to help provide fault tolerance, fail-over, load-balancing, and/or stability and each of cloud computing regions 910 can be composed of multiple availability zones, each of which can be a separate data center located in general proximity to each other (e.g., within 600 miles). Further, each of cloud computing regions 910 may provide superior service to a particular geographic region based on physical proximity. For example, cloud computing region 910-1 may have its datacenters and hardware located in the northeast of the United States while cloud computing region 910-2 may have its datacenters and hardware located in California. For simplicity, the details of the cellular network as executed in only cloud computing region 910-1 is illustrated. Similar components may be executed in other cloud computing regions of cloud computing regions 910 (910-2, 910-3, 910-n).

In other embodiments, cloud computing platform 901 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 910 may include multiple availability zones 915. Each of availability zones 915 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 915. For example, a database that is maintained as part of NDC 930 may be replicated across availability zones 915; therefore, if an availability zone of the cloud computing region is unavailable, a copy of the database remains up-to-date and available, thus allowing for continuous or near continuous functionality.

On a (e.g., public) cloud computing platform, cloud computing region 910-1 may include the ability to use a different type of data center or group of data centers, which can be referred to as local zones 920. For instance, a client, such as a provider of the hybrid cloud cellular network, can select from more options of the computing resources that can be reserved at an availability zone 915 compared to a local zone 920. However, a local zone 920 may provide computing resources nearby geographic locations where an availability zone 915 is not available. Therefore, to provide low latency, certain network components, such as regional data centers 940, can be implemented at local zones 920 rather than availability zones 915. In some circumstances, a geographic region can have both a local zone 920 and an availability zone 915.

In the topology of a 5G NR cellular network, 5G core functions of core 839 can logically reside as part of a national data center (NDC) 930. NDC 930 can be understood as having its functionality existing in cloud computing region 910-1 across multiple availability zones 915. At NDC 930, various network functions, such as NFs 932, are executed. For illustrative purposes, each NF 932, whether at NDC 930 or elsewhere located, can be comprised of multiple sub-components, referred to as pods (e.g., pod 911) that are each executed as a separate process by the cloud computing region 910. The illustrated number of pods 911 is merely an example; fewer or greater numbers of pods 911 may be part of the respective 5G core functions. It should be understood that in a real-world implementation, a cellular network core, whether for 5G or some other standard, can include many more network functions. By distributing NFs 932 across availability zones 915, load-balancing, redundancy, and fail-over can be achieved. In local zones 920, multiple regional data centers 940 can be logically present. Each of regional data centers 940 may execute 5G core functions for a different geographic region or group of RAN components. As an example, 5G core components that can be executed within an RDC, such as RDC 940-1, may be: UPFs 950, SMFs 960, and AMFs 970. While instances of UPFs 950 and SMFs 960 may be executed in local zones 920, SMFs 960 may be executed across multiple local zones 920 for redundancy, processing load-balancing, and fail-over.

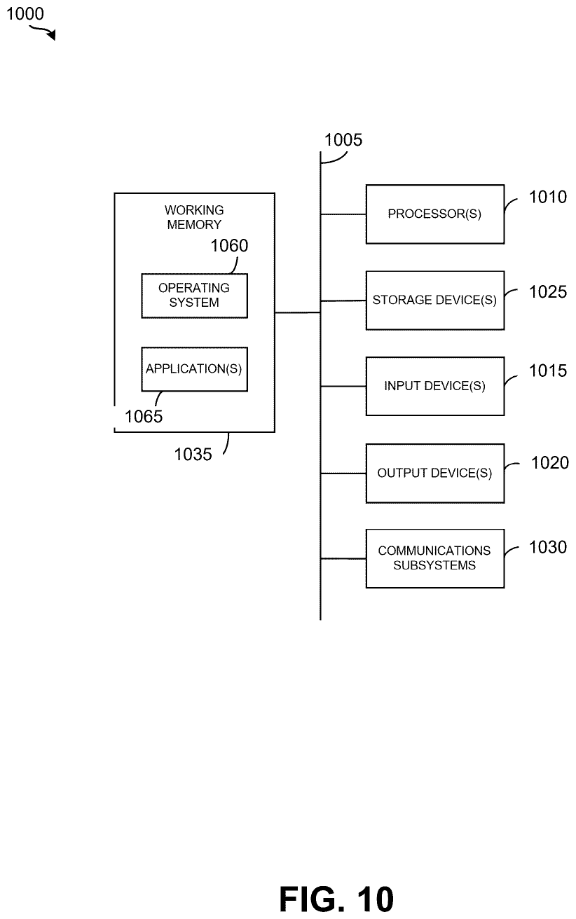

FIG. 10 is a schematic diagram illustrating an example of computer system 1000. The computer system 1000 is a simplified computer system that can be used to implement various embodiments described and illustrated herein. A computer system 1000 as illustrated in FIG. 5 may be incorporated into devices such as a portable electronic device, mobile phone, or other device as described herein. FIG. 10 provides a schematic illustration of one embodiment of a computer system 1000 that can perform some or all of the steps of the methods and workflows provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown including hardware elements that can be electrically coupled via a bus 1005, or may otherwise be in communication, as appropriate. The hardware elements may include one or more processors 1010, including without limitation one or more general-purpose processors and/or one or more special-purpose processors such as digital signal processing chips, graphics acceleration processors, and/or the like; one or more input devices 1015, which can include without limitation a mouse, a keyboard, a camera, and/or the like; and one or more output devices 1020, which can include without limitation a display device, a printer, and/or the like.

The computer system 1000 may further include and/or be in communication with one or more non-transitory storage devices 1025, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1060, which can include without limitation a modem, a network card (wireless or wired), an infrared communication device, a wireless communication device, and/or a chipset such as a Bluetooth™ device, a 802.11 device, a WiFi device, a Wi-Max device, cellular communication facilities, etc., and/or the like. The communications subsystem 1030 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1030. In other embodiments, a portable electronic device, e.g., the first electronic device, may be incorporated into the computer system 1000, e.g., an electronic device as an input device 1015. In some embodiments, the computer system 1000 will further include a working memory 1035, which can include a RAM or ROM device, as described above.

The computer system 1000 also can include software elements, shown as being currently located within the working memory 1035, including an operating system 1060, device drivers, executable libraries, and/or other code, such as one or more application programs 1065, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 10, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1025 described above. In some cases, the storage medium might be incorporated within a computer system, such as computer system 1000. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 1000 and/or might take the form of source and/or installable code, which, upon compilation and/or installation on the computer system 1000 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1000 to perform methods in accordance with various embodiments of the technology. According to a set of embodiments, some or all of the operations of such methods are performed by the computer system 1000 in response to processor 1010 executing one or more sequences of one or more instructions, which might be incorporated into the operating system 1060 and/or other code, such as an application program 1065, contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 and/or components thereof generally will receive signals, and the bus 1005 then might carry the signals and/or the data, instructions, etc. carried by the signals to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of automatically updating active registered locations for use in emergency calls, the method comprising:
determining, by a computing device, a current location of the computing device based at least in part on sensors of the computing device;
accessing, by the computing device, data indicating each of a plurality of registered locations and an active registered location associated with the computing device;
determining, by the computing device, that the current location corresponds to a second registered location, different than the active registered location; and
updating, by the computing device, the active registered location to indicate the current location.

2. The method of claim 1, wherein the computing device updates the active registered location automatically.

3. The method of claim 1, further comprising:
responsive to determining that the current location corresponds to the second registered location, different than the active registered location:
generating, by the computing device, a notification indicating that the current location corresponds to the second registered location, different than the active registered location; and
receiving, by the computing device, an input causing the computing device to update the active registered location to indicate the current location.

4. The method of claim 1, further comprising:
determining, by the computing device, a particular registered location of the plurality of registered locations that is an unvisited registered location;
generating, by the computing device, a notification indicating that the particular registered location has not been visited; and
receiving, but the computing device, an input causing the computing device to remove the particular registered locations from the plurality of registered locations.

5. The method of claim 1, wherein the active registered location is updated based at least in part on the computing device connecting to a particular wireless network.

6. The method of claim 1, further comprising:
determining, by the computing device, that the computing device has moved to a certain proximity away from the active registered location; and
updating the active registered location to indicate the current location.

7. The method of claim 1, wherein the current location is determined at least in part by network information associated with a WiFi network.

8. A system, comprising:
one or more processors; and
a computer-readable medium comprising instructions that, when executed by the one or more processors, cause the system to perform operations to:
determine, by a computing device, a current location of the computing device based at least in part on sensors of the computing device;
access, by the computing device, data indicating each of a plurality of registered locations and an active registered location associated with the computing device;
determine, by the computing device, that the current location corresponds to a second registered location, different than the active registered location; and
update, by the computing device, the active registered location to indicate the current location.

9. The system of claim 8, wherein the computing device updates the active registered location automatically.

10. The system of claim 8, wherein responsive to determining that the current location corresponds to the second registered location, different than the active registered location, the operations further cause the system to:
generate, by the computing device, a notification indicating that the current location corresponds to the second registered location, different than the active registered location; and
receive, by the computing device, an input causing the computing device to update the active registered location to indicate the current location.

11. The system of claim 8, wherein the operations further cause the system to:
determine, by the computing device, a particular registered location of the plurality of registered locations that is an unvisited registered location;
generate, by the computing device, a notification indicating that the particular registered location has not been visited; and
receive, but the computing device, an input causing the computing device to remove the particular registered locations from the plurality of registered locations.

12. The system of claim 8, wherein the active registered location is updated based at least in part on the computing device connecting to a particular wireless network.

13. The system of claim 8, further comprising:
determine, by the computing device, that the computing device has moved to a certain proximity away from the active registered location; and
update the active registered location to indicate the current location.

14. The system of claim 8, wherein the current location is determined at least in part by network information associated with a WiFi network.

15. A non-transitory computer-readable memory comprising instructions that, when executed by one or more processors, cause the one or more processors to perform operations comprising:
determining, by a computing device, a current location of the computing device based at least in part on sensors of the computing device;
accessing, by the computing device, data indicating each of a plurality of registered locations and an active registered location associated with the computing device;
determining, by the computing device, that the current location corresponds to a second registered location, different than the active registered location; and
updating, by the computing device, the active registered location to indicate the current location.

16. The non-transitory computer-readable memory of claim 15, wherein the computing device updates the active registered location automatically.

17. The non-transitory computer-readable memory of claim 15, the operations further comprising:
responsive to determining that the current location corresponds to the second registered location, different than the active registered location:
generating, by the computing device, a notification indicating that the current location corresponds to the second registered location, different than the active registered location; and
receiving, by the computing device, an input causing the computing device to update the active registered location to indicate the current location.

18. The non-transitory computer-readable memory of claim 15, the operations further comprising:
determining, by the computing device, a particular registered location of the plurality of registered locations that is an unvisited registered location;
generating, by the computing device, a notification indicating that the particular registered location has not been visited; and
receiving, but the computing device, an input causing the computing device to remove the particular registered locations from the plurality of registered locations.

19. The non-transitory computer-readable memory of claim 15, wherein the active registered location is updated based at least in part on the computing device connecting to a particular wireless network.

20. The non-transitory computer-readable memory of claim 15, the operations further comprising:
determining, by the computing device, that the computing device has moved to a certain proximity away from the active registered location; and
updating the active registered location to indicate the current location.
